(19) United States
(12) Patent Application Publication
(10) Pub. No.: US 2003/0198051 A1
(43) Pub. Date: Oct. 23, 2003

(54) Image mirror lamp

(76) Inventor: Shun Liu, Taipei Hsien (TW)

Correspondence Address: Shun Liu, P.O. Box No. 6-57, Chung-Ho, Taipei, 235, TW

(21) Appl. No.: 10/125,383

(22) Filed: Apr. 19, 2002

(51) Int. Cl. F21V 7/00

(52) U.S. Cl. 362/296; 362/297; 362/341

(57) ABSTRACT

An image mirror lamp mainly includes a lamp case and a double-sided mirror, wherein the lamp case has an opening disposed with a spherical lamp cup and a light bulb therein; the double-sided mirror is disposed at the front aspect of the lamp case opening. According to the abovementioned structure, when the power is turned on, the light ray emitted from the light bulb transmits outwardly from the interior portion of the double-sided mirror to form a lamp decoration; when the light bulb is turned off, the double-sided mirror is not diaphanous such that it functions as a regular mirror.

### BACKGROUND OF THE INVENTION

1) Field of the Invention

The present invention relates to an image mirror lamp, more particularly to a mirror lamp comprising a lamp case and a double-sided mirror, wherein, a light bulb is disposed in the lamp case. When the power is turned on, the light ray emitted from the light bulb transmits outwardly from the interior portion of the double-sided mirror to form a lamp decoration; when the light bulb is turned off, the double-sided mirror is not diaphanous such that it functions as a regular mirror.

2) Description of the Prior Art

Accordingly, conventional mirrors can be categorized as a desk mirror to be placed on a desk, a wall mirror to be hung on a wall or a small mirror to be stored in a handbag. No matter how it is placed, the mirror frame or the storage function thereof are the most alterable portions. However, the function of mirror is limited to reflecting purpose. Alternation of this kind is considered monotonous and boring.

Furthermore, mostly, the style of a decorative lamp is the focus of new design. However, it is usually stereotyped, such as a desk lamp with a cylindrical lamp shade, a lamp base with a character figure, etc.; therefore, the alternation thereof is considered monotonous and lack of innovative effect.

In addition, usually a photograph or picture is framed to facilitate conveniently hanging up on a wall by a string or placing on a desk by a support disposed at the rear aspect thereof. However, the frame style is monotonous and lack of innovation since it is formulated and unable to break through the traditional patterns.

### SUMMARY OF THE INVENTION

In summation of the abovementioned shortcomings of the conventional mirrors, the inventor of the present invention designed an image mirror lamp mainly comprising a lamp case and a double-sided mirror, wherein the lamp case has an opening disposed with a spherical lamp cup and a light bulb therein; the double-sided mirror is disposed at the front aspect of the lamp case opening. According to the abovementioned structure, when the power is turned on, the light ray emitted from the light bulb transmits outwardly from the interior portion of the double-sided mirror to form a lamp decoration; when the light bulb is turned off, the double-sided mirror is not diaphanous such that it functions as a regular mirror.

Therefore, the primary objective of the present invention is to provide a mirror lamp comprising a lamp case and a double-sided mirror with a light bulb disposed inside the lamp case. When the power is turned on, the light ray emitted from the light bulb transmits outwardly from the interior portion of the double-sided mirror to form a lamp decoration; when the light bulb is turned off, the double-sided mirror is not diaphanous such that it functions as a regular mirror.

To enable a further understanding of the structural features and the technical contents of the present invention, the brief description of the drawings below is followed by the detailed description of the preferred embodiment.

### BRIEF DESCRIPTION OF THE DRAWINGS

FIG. 1 is a perspective and exploded drawing of the present invention.

FIG. 2 is a cross-sectional drawing of the assembly of the present invention.

FIG. 3 is a perspective and exploded drawing of another exemplary embodiment of the present invention.

FIG. 4 is the first perspective and exploded drawing of the embodiment of the present invention disposed with an external frame.

FIG. 5 is the second perspective and exploded drawing of the embodiment of the present invention disposed with an external frame.

FIG. 6 is the third perspective and exploded drawing of the embodiment of the present invention disposed with an external frame.

FIG. 7 is the fourth perspective and exploded drawing of the embodiment of the present invention disposed with an external frame.

FIG. 8 is a perspective and exploded drawing of yet another embodiment of the present invention.

FIG. 9 is a cross-sectional drawing of the assembly of the embodiment in FIG. 8.

### DETAILED DESCRIPTION OF THE PREFERRED EMBODIMENTS

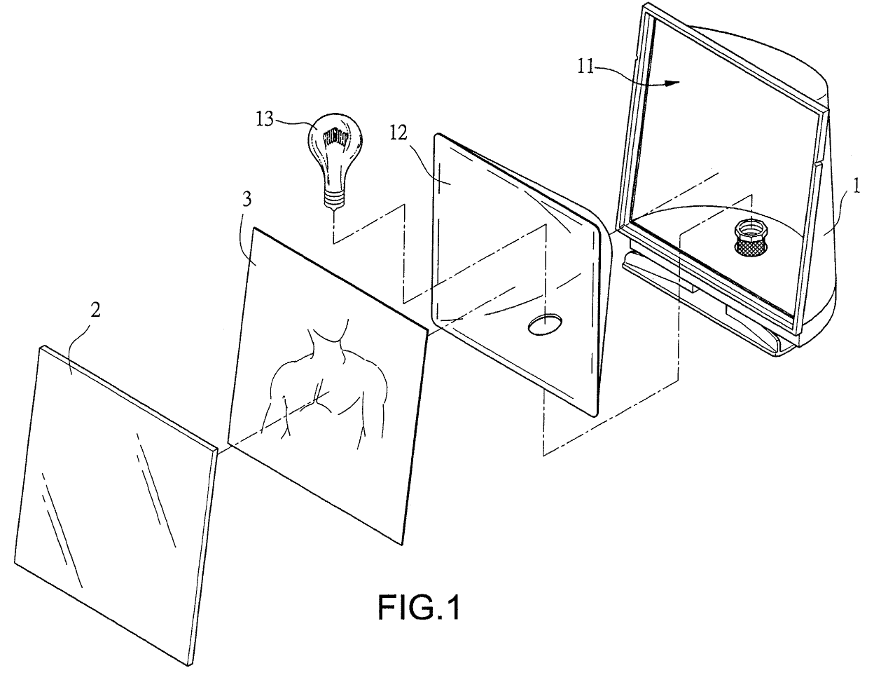

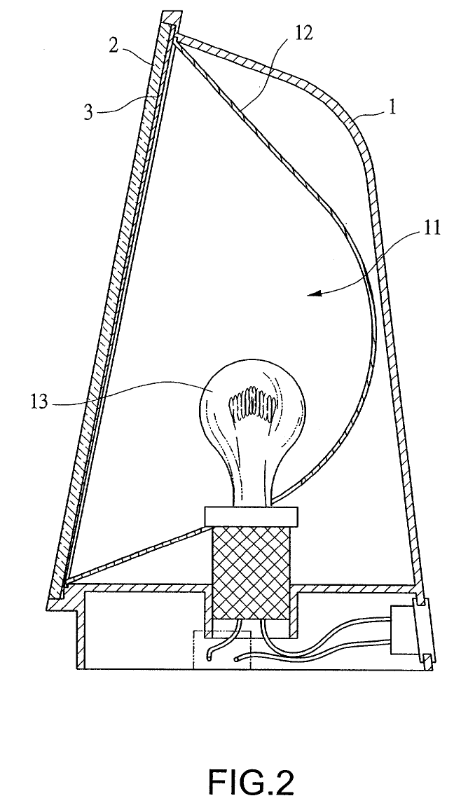

Referring to FIGS. 1 and 2, the present invention mainly comprises a lamp case (1) and a double-sided mirror (2), wherein, the lamp case (1) has an opening (11) disposed with a spherical lamp cup (12) and a light bulb (13) therein; the double-sided mirror (2) is disposed at the front aspect of the lamp case (1) opening (11). When the power is turned on, the light ray emitted from the light bulb (13) transmits outwardly from the interior portion of the double-sided mirror (2) to form a lamp decoration; when the power is turned off, the double-sided mirror (2) is not diaphanous such that it functions as a regular mirror.

According to the abovementioned structure, since the double-sided mirror (2) only transmits light ray in a mono-direction, when the light bulb (13) installed inside the lamp case (1) is turned on, the light ray generated from the light bulb (13) has to penetrate through the double-sided mirror (2) thereby forming a lamp decoration.

Furthermore, when the light bulb (13) installed inside the lamp case (1) is turned off, since the double-sided mirror (2) only transmits light ray in a mono-direction and its inner plane is located on the opening (11) of the not diaphanous lamp case (1), the interior portion of the double-sided mirror (2) is dark under the lightless situation such that the double-sided mirror (2) functions as a regular mirror.

Therefore, it merely needs to control the light bulb (13) in the lamp case (1) to make the present invention have dual effects of functioning as an image lamp mirror or a regular mirror.

A diaphanous photograph (3) is disposed between the light bulb (13) and the double-sided mirror (2) for diffusing the light ray in dots to generate colorful radiant light spots; for optional application, the diaphanous photograph (3) can be an image transparent sheet to be framed in a box lamp, or the image can be directly printed on the bottom plane of the double-sided mirror (2) for achieving the same effect. These are the other embodiments provided for reference purpose.

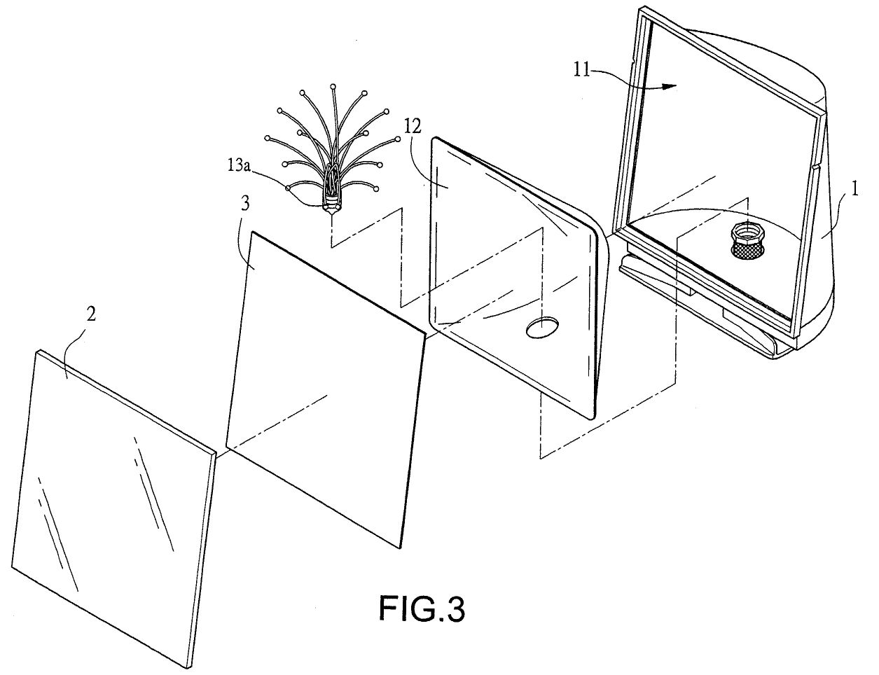

Referring to FIG. 3, the light bulb (13) is designed according to the need as a mini flash lamp (13a) to achieve the abovementioned effect.

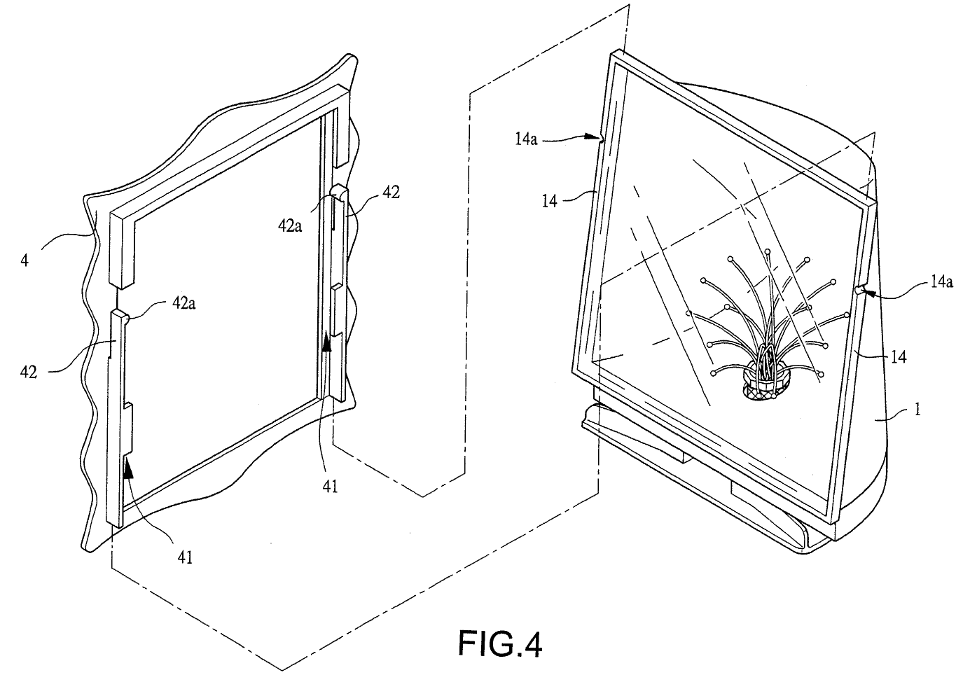

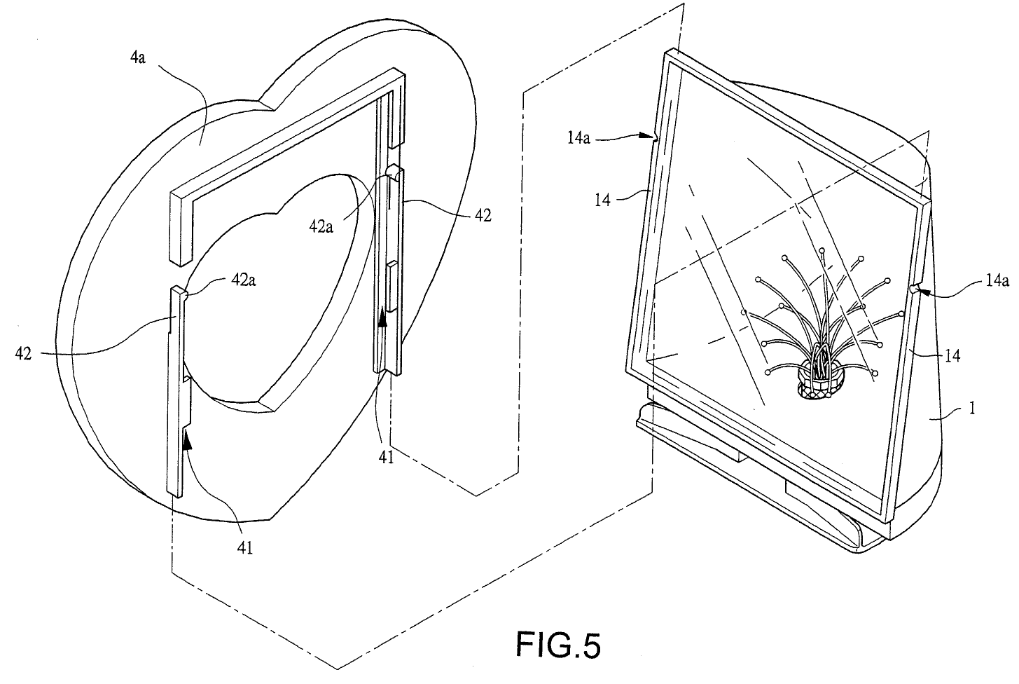

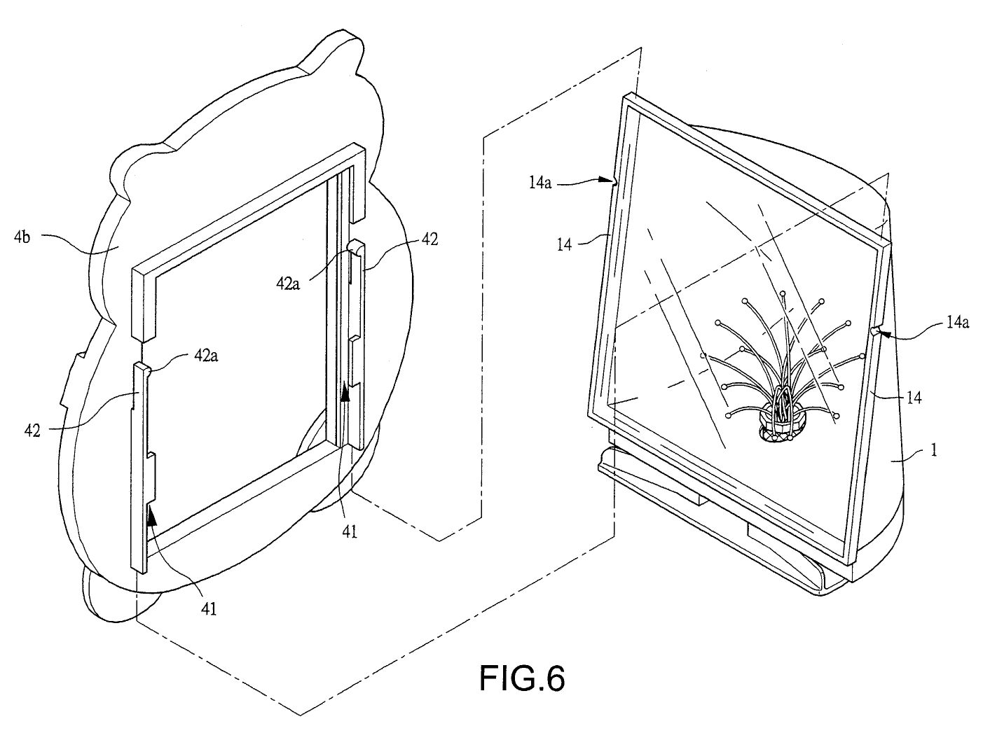

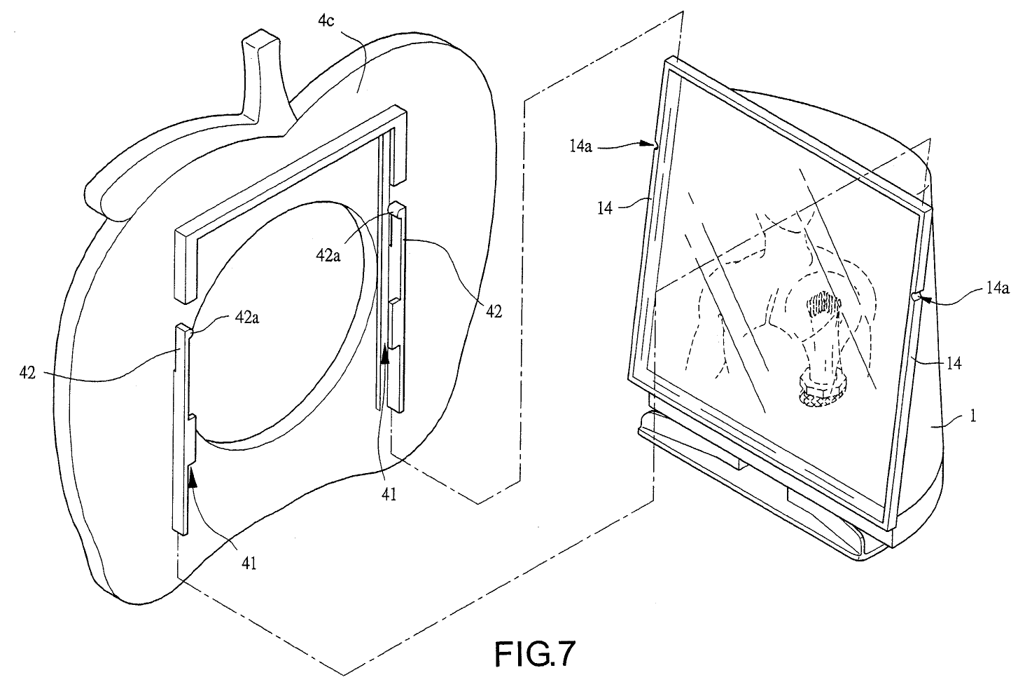

Referring to FIGS. 4 to 7, the front aspect of the lamp case (1) opening (11) is installed with an external frame (4, 4a, 4b or 4c) disposed with two opposite engage slots (41) on the back plane thereof; an elastic piece (42) with a convex point (42a) is disposed on the engage slot (41); convex rims (14) opposite the engage slot (41) are disposed on the two lateral sides of the lamp case (1) opening (11); on the convex rim (14), a concave slot (14a) opposite the convex point (42a) of the elastic piece (42a) is disposed to provide simple and convenient installation and detachment of the external frame (4, 4a, 4b or 4c) on or from the front aspect of the lamp case (1) for replacement; furthermore, the external frame (4, 4a, 4b or 4c) beautifies the lamp case (1). That is another embodiment of the present invention.

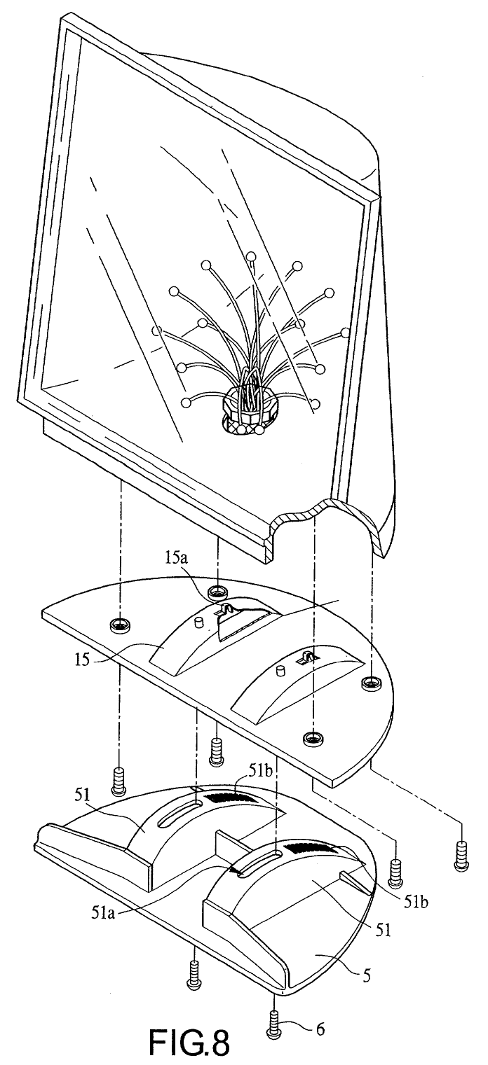

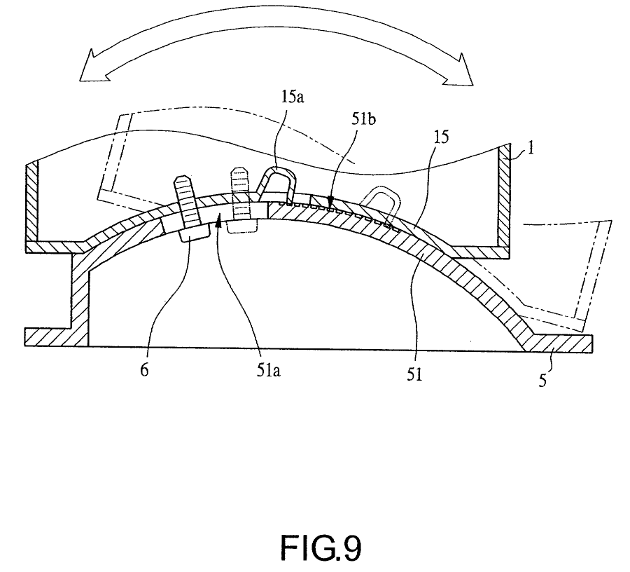

Referring to FIGS. 8 and 9, the bottom portion of the lamp case (1) is disposed with an arcuate concave slot (15) with an elastic retaining piece (15a) disposed on the top plane thereof. Furthermore, an arcuate convex seat (51) opposite the arcuate concave slot (15) is disposed on the bottom base (5). A guide slot (51a) and a buttress gang retainer (51b) are disposed on the arcuate convex seat (51); a screw (6) penetrates the guide slot (51a) of the arcuate convex seat (51) to conjoin with the bottom portion of the lamp case (1) thereby pushing the elastic engage piece (15a) of the arcuate concave slot (15) against the buttress gang retainer (51b) on the arcuate convex seat (51) for adjusting the angle of the lamp case (1). This is another embodiment of the present invention.

It is of course to be understood that the embodiment described herein is merely illustrative of the principles of the invention and that a wide variety of modifications thereto may be effected by persons skilled in the art without departing from the spirit and scope of the invention as set forth in the following claims.

1. An image lamp mirror comprising:
a lamp case has an opening disposed with a spherical lamp cup and a light bulb therein;
a double-sided mirror is disposed at the front aspect of the lamp case opening; when the power is turned on, the light ray emitted from the light bulb transmits outwardly from the interior portion of the double-sided mirror to form a lamp decoration; when the light bulb is turned off, the double-sided mirror is not diaphanous such that it functions as a regular mirror.

2. An image lamp mirror according to claim 1, wherein a diaphanous photograph is disposed between the light bulb and the double-sided mirror; the diaphanous photograph is a fringe piece diffusing the light ray in dots to generate colorful radiant light spots.

3. An image lamp mirror according to claim 1, wherein a diaphanous photograph is disposed between the light bulb and the double-sided mirror; the diaphanous photograph is a transparent sheet with a colorful image to be framed as a box lamp type frame.

4. An image lamp mirror according to claim 1, wherein various images are printed on the bottom plane of the double-sided mirror to form a box lamp type frame.

5. An image lamp mirror according to claim 1, wherein a light source is a mini colorful flash lamp.

6. An image lamp mirror according to claim 1, wherein the front aspect of the lamp case opening is installed with an external frame disposed with two opposite engage slots on the back plane thereof; an elastic piece with a convex point is disposed on the engage slot; convex rims opposite the engage slot are disposed on the two lateral sides of the lamp case opening; on the convex rim, a concave slot opposite the convex point of the elastic piece is disposed allowing the external frame to be simply and conveniently installed on or detached from the front aspect of the lamp case for replacing with external frames of different styles.

7. An image lamp mirror according to claim 1, wherein the bottom portion of the lamp case is disposed with an arcuate concave slot with an elastic retaining piece disposed on the top plane thereof; an arcuate convex seat opposite the arcuate concave slot is disposed on the bottom base; a guide slot and a buttress gang retainer are disposed on the arcuate convex seat; a screw penetrates the guide slot of the arcuate convex seat to conjoin with the bottom portion of the lamp case thereby pushing the elastic engage piece of the arcuate concave slot against the buttress gang retainer on the arcuate convex seat for adjusting the angle of the lamp case.
